(19) United States
(12) Patent Application Publication
(10) Pub. No.: US 2008/0087701 A1
(43) Pub. Date: Apr. 17, 2008

(54) Adhesive tape dispenser with releasing sheets

(76) Inventor: Allen F.C. Hsieh, Jhongli City (TW)

Correspondence Address: RABIN & Berdo, PC, 1101 14TH STREET, NW, SUITE 500, WASHINGTON, DC, 20005, US

(21) Appl. No.: 11/545,572

(22) Filed: Oct. 11, 2006

(51) Int. Cl. B26F 3/02

(52) U.S. Cl. 225/39

(57) ABSTRACT

An adhesive tape dispenser with releasing sheets has a base, a blade assembly and a releasing sheet assembly. The base has a tape holder and an upper surface. The tape holder is formed on and protrudes up from the base and holds a roll of adhesive tape. The blade assembly is mounted on the upper surface and has a blade. The releasing sheet assembly is mounted on the upper surface between the tape holder and the blade assembly and has a housing, at least one spring and multiple releasing sheets. The spring is mounted in the housing. The releasing sheets are mounted in the housing. When pulling the adhesive tape, a user can hold the releasing sheet so the user's fingers do not touch adhesive on the adhesive tape.

### BACKGROUND OF THE INVENTION

1. Field of the Invention

The present invention relates to an adhesive tape dispenser, and especially to an adhesive tape dispenser to keep a user's fingers from touching adhesive on adhesive tape when pulling the adhesive tape so oil, grease or other contaminants on the adhesive tape are not deposited on the adhesive tape and keep the user's fingers from getting sticky.

2. Description of the Related Art

A conventional adhesive tape dispenser comprises a base, a tape bolder and a blade assembly. The base has a front end and a rear end. The tape holder holds a roll of adhesive tape and is formed on and protrudes up from the rear end of the base. The blade assembly is formed on and protrudes up from the base near the front end and comprises a mount and a blade. The blade is mounted on and protrudes from the mount.

When a user pulls adhesive tape from the adhesive tape dispenser, the user pulls the adhesive tape up and outward with the user's finger. Then the user pulls the adhesive tape down across the blade to cut the adhesive tape. However, the user's fingers become sticky from touching the adhesive on the adhesive tape. Furthermore, oil, grease or other contaminants on a user's fingers are deposited on the tape that decreases the adhesion of the adhesive tape.

In addition, removing adhesive tape from paper is particularly difficult, especially getting one end of a piece of adhesive tape free from the paper. Although a conventional releasing sheet or paper tab can be used, the releasing sheet or paper tab must be attached to the end of the adhesive tape before the adhesive tape is stuck to the paper, which is not convenient.

### SUMMARY OF THE INVENTION

The objective of the present invention is to provide an adhesive tape dispenser with releasing sheets, which keeps a user's fingers from touching adhesive on adhesive tape when pulling the adhesive tape so oil, grease or other contaminants on a user's fingers are not deposited on the adhesive tape and adhesive from the adhesive tape does not get on the user's fingers.

To achieve the foregoing objective, an adhesive tape dispenser with releasing sheets in accordance with the present invention has a base, a blade assembly and a releasing sheet assembly. The base has a tape holder and an upper surface. The tape holder is formed on and protrudes up from the base and holds a roll of adhesive tape. The blade assembly is mounted on the upper surface and has a blade. The releasing sheet assembly is mounted on the upper surface between the tape holder and the blade assembly and comprises a housing, at least one spring and multiple releasing sheets. The housing is mounted on the upper surface and between the tape holder and the blade assembly. The at least one spring is mounted in the housing. The releasing sheets are mounted in the housing above the at least one spring. When pulling the adhesive tape, a user can hold the releasing sheet so the user's fingers do not touch adhesive on the adhesive tape. Therefore, oil, grease or other contaminants on a user's fingers are not deposited on the adhesive tape, and a user's fingers do not get sticky.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an adhesive tape dispenser with sheets in accordance with the present invention;

FIG. 2 is an operational perspective view of the adhesive tape dispenser in FIG. 1 pulling a sheet;

FIG. 3 is a side view in partial section of the adhesive tape dispenser in FIG. 1;

FIG. 4 is an operational perspective view of the adhesive tape dispenser in FIG. 1 when tape is pulled up and outward;

FIG. 5 is a side view in partial section of the adhesive tape dispenser in FIG. 4;

FIG. 6 is a perspective view of the adhesive tape dispenser in FIG. 1 after a blade cuts the tape; and

FIG. 7 is a side view in partial section of a second embodiment of the adhesive tape dispenser with sheets in accordance with the present invention.

### DETAILED DESCRIPTION OF THE PREFERRED EMBODIMENTS

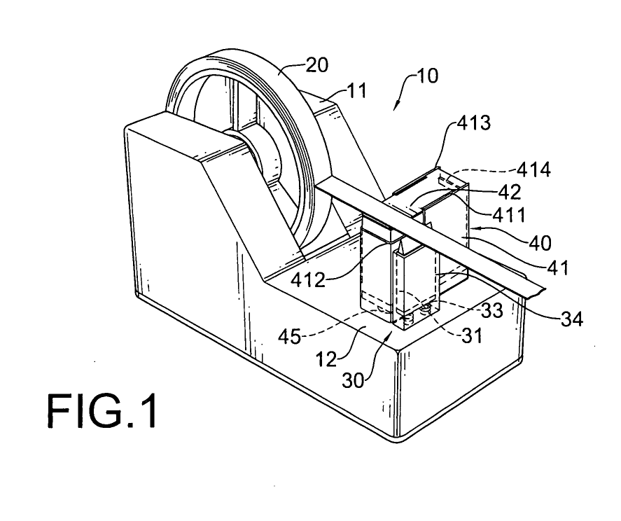

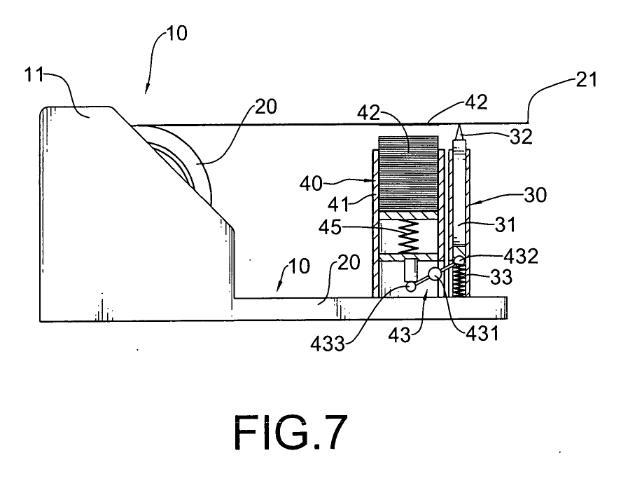

With reference to FIGS. 1 and 7, an adhesive tape dispenser with releasing sheets in accordance with the present invention comprises a base (10), a blade assembly (30) and a releasing sheet assembly (40).

The base (10) comprises a rear end, a front end, an upper surface (12) and a tape holder (11). The tape holder (11) is formed on and protrudes up from the base (10) at the rear end and rotatably holds a roll of adhesive tape (20).

The blade assembly (30) is mounted on and protrudes up from the upper surface (12) of the base (10), cuts a desired length of adhesive tape (21) pulled from the roll of adhesive tape (20) in the tape holder (11) and comprises a blade box (34), a blade base (31), a blade (32) and at least one spring (33). The blade box (34) is mounted on and protrudes up from the upper surface (12) of the base (10) near the front end and has a bottom and an open top. The blade base (31) is mounted on and protrudes up from the upper surface (12) of the base (10) near the front end, may be mounted slidably in the blade box (34) and has a top and a bottom. The blade (32) is mounted on and protrudes longitudinally from the top of the blade base (31) out of the blade box (34). The at least one spring (33) is mounted in the blade box (34) between the bottom of the blade box (34) and the bottom of the blade base (31).

The releasing sheet assembly (40) is mounted on and protrudes up from the upper surface (12) of the base (10) between the tape holder (11) and the blade assembly (30) and comprises a housing (41), at least one spring (45), multiple releasing sheets (42) and an ejection lever (43).

The housing (41) is mounted on the upper surface (12) between the tape holder (11) and the blade assembly (30) and comprises an open top (411), a bottom, an inner end, an outer end, a cutout (412), two ribs (413) and a recess (414). The open top (411) of the housing (40) may be lower than the top of the blade (32), may be rectangular and has two longitudinal edges. The longitudinal edges are perpendicular to adhesive tape (21) pulled from the adhesive tape (20) in the tape holder (11). The cutout (412) is formed in the inner end of the housing (41) and communicates with the open top (411). The ribs (413) are formed respectively on and protrude in from the longitudinal edges. The recess (414) is formed in outer end of the housing (41) and communicates with the open top (411).

The at least one spring (45) is mounted between the bottom of the housing (41) and the open top (411).

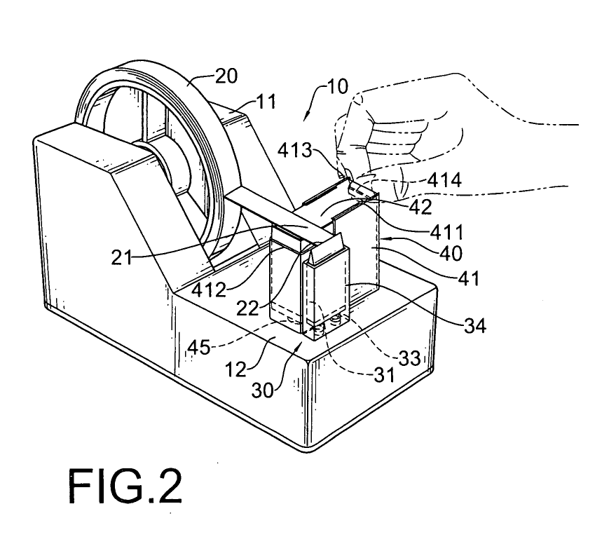

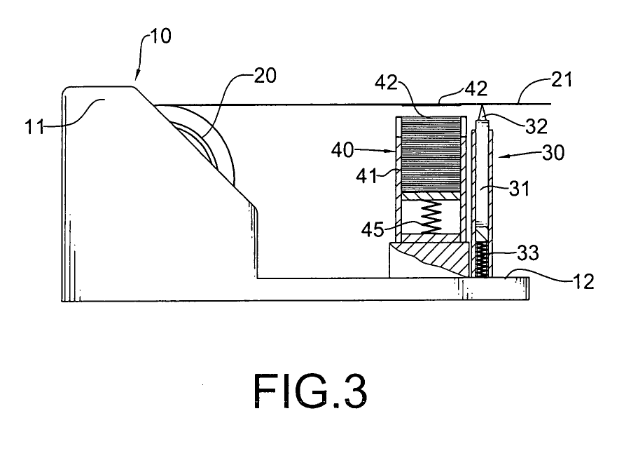

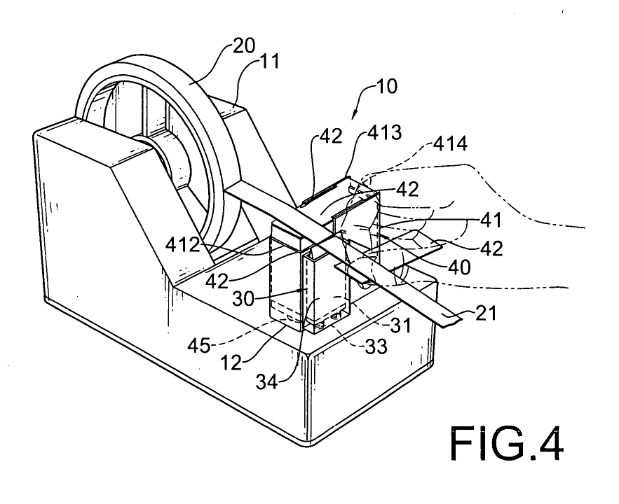

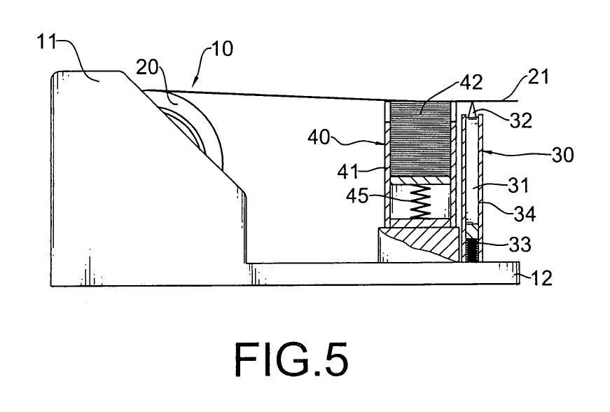

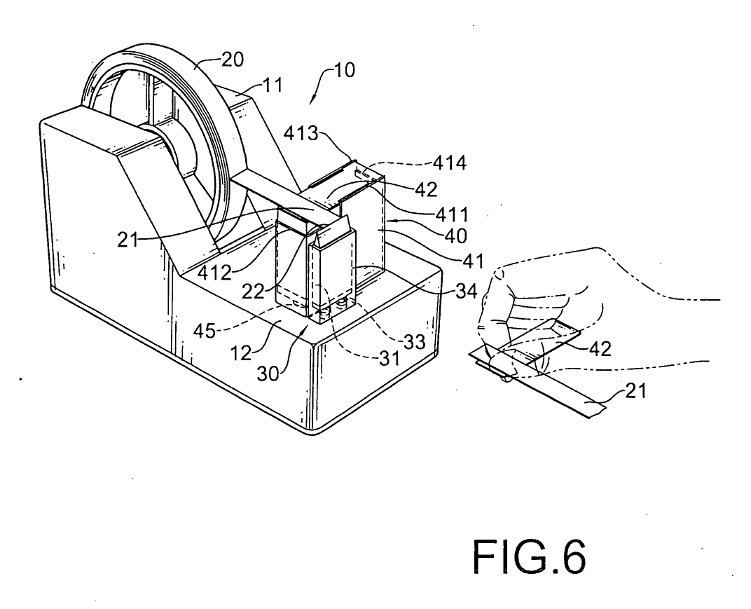

The releasing sheets (42) are mounted in the housing (41) between the at least one spring (45) and open top (411) and are held in the housing (41) by the ribs (413). With further reference to FIGS. 2 to 6, pressing the adhesive tape (21) against the releasing sheet (42) at the open top (411) causes the adhesive tape (21) to pick up a releasing sheet (42) and allow adhesive tape (21) to be pulled from the dispenser without touching adhesive on the adhesive tape (21) and allow the adhesive tape (21) to be removed from paper to which the adhesive tape (21) sticks.

The ejection lever (43) is mounted between the blade assembly (30) and the releasing sheet assembly, presses the releasing sheets (42) in the housing (41) against the adhesive tape (21) when the blade (32) is pressed down to cut the adhesive tape (21) and comprises a pivot (431), an outer end (432) and an inner end (433). The pivot (431) maybe mounted between the blade assembly (30) and the releasing sheet assembly (40). The outer end (432) is attached to the blade base (31). The inner end (433) is attached to the at least one spring (45) in the releasing sheet assembly (40). Therefore, the at least one spring (45) is raised by the ejection lever (43) and pushes the releasing sheets (50) up against the adhesive tape (21) when the blade (32) and the blade base (31) are pressed down when the adhesive tape (21) is cut.

The adhesive tape dispenser as described has the advantage of keeping a person's fingers from having to touch adhesive on adhesive tape when pulling the adhesive tape so oil, grease or other contaminants on the person's fingers are not deposited on the adhesive tape and adhesive from the adhesive tape does not stick to the person's fingers.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adhesive tape dispenser comprising
a base having
a rear end;
a front end;
an upper surface; and
a tape holder being formed on and protruding up from the base at the rear end and adapted to rotatably hold a roll of adhesive tape;
a blade assembly being mounted on and protruding up from the upper surface of the base for cutting a desired length of adhesive tape pulled from the roll of adhesive tape in the tape holder and comprising
a blade base being mounted on and protruding up from the upper surface of the near the front end and having
a top; and
a bottom; and
a blade being mounted on and protruding longitudinally from the top of the blade base; and
a releasing sheet assembly being mounted on and protruding up from the upper surface of the base between the tape holder and the blade assembly and comprising
a housing being mounted on the upper surface and between the tape holder and the blade assembly and comprising
an open top;
a bottom;
an inner end; and
an outer end;
at least one spring being mounted between the bottom of the bottom of the housing and the open top; and
multiple releasing sheets being mounted in the housing between the at least one spring and open top.

2. The adhesive tape dispenser as claimed in claim 1, wherein
the blade assembly further comprises
a blade box mounted on and protruding up from the upper surface of the base near the front end and having
a bottom; and
an open top;
the blade base is mounted slidably in the blade box;
the blade protrudes out of the blade box; and
the blade assembly further comprises at least one spring mounted in the blade box between the bottom of the blade box and the bottom of the blade base.

3. The adhesive tape dispenser as claimed in claim 2 wherein
the open top of the housing is rectangular and has two longitudinal edges adapted to be perpendicular to adhesive tape pulled from adhesive tape in the tape holder; and
the container further comprises
a cutout formed in the inner end of the housing and communicating with the open top;
two ribs formed respectively on and protruding in from the longitudinal edges to hold the releasing sheets in the housing; and
a recess formed in the outer end of the housing and communicating with the open top.

4. The adhesive tape dispenser as claimed in claim 3, wherein the releasing sheet assembly further comprises an ejection lever mounted between the blade assembly and the releasing sheet assembly and comprising
a pivot mounted between the blade device and the sheet device;
an outer end attached to the blade base; and
an inner end attached to the at least one spring in the releasing sheet assembly.

5. The adhesive tape dispenser as claimed in claim 1 wherein the open top of the housing is lower than the blade.
